(19) United States
(12) Patent Application Publication
(10) Pub. No.: US 2016/0019761 A1
(43) Pub. Date: Jan. 21, 2016

(54) WIRELESS EYEWEAR LOCATING DEVICE AND METHOD OF USE

(71) Applicant: Global Specs., Inc., New York, NY (US)

(72) Inventor: Penny Lieberman, New York, NY (US)

(21) Appl. No.: 14/506,872

(22) Filed: Oct. 6, 2014

Related U.S. Application Data
(60) Provisional application No. 62/025,517, filed on Jul. 17, 2014.

(51) Int. Cl. G08B 5/36

(52) U.S. Cl. CPC G08B 5/36

(57) ABSTRACT

The present invention and method relates to a wireless locating device which can be used to locate objects such as pieces of eyewear. The tracking apparatus of present invention can be embedded within, or attached to objects such as a piece of eyewear or a eyewear frame, which can be located through the use of at least one software application in conjunction with at least one control device, such as a remote control, a mobile device, smart device, and/or a stationary device.

### PRIORITY

This application claims priority to U.S. Provisional Utility Patent Application No. 62/025,517 for the invention titled “WIRELESS EYEWEAR LOCATING DEVICE AND METHOD OF USE” with a filing date of Jul. 17, 2014, which is incorporated herein by reference for all purposes.

### FIELD OF THE INVENTION

The present invention relates to location devices. More particularly, the present invention relates to location devices used to determine the location of certain items or objects. The presently disclosed subject matter relates to eyewear accessories.

### BACKGROUND OF THE INVENTION

Currently, there are a number of ways in which a person can find a lost piece of eyewear, including physically searching for a lost item, or relying on tracking devices that are limited in their range of location detection. Additionally, there are currently a number of tracking devices used to locate lost items that require that a user attach a tracking device onto a lost item. The present invention provides a person who has lost a piece of eyewear with a solution to monitor and/or track the location of such eyewear, and allows for an embed devise within the eyewear unit or in another embodiment the user can either attach or embed the present invention in or to a piece of eyewear. By utilizing one or more of various types of signals, the present invention allows a user to wirelessly locate a lost or misplaced piece of eyewear that may also not even be within the limited range of other available tracking devices. By allowing a user to attach the present invention in or to a piece of eyewear, a user is provided with the ability to use the present invention on a number of pieces of eyewear. By allowing a user to embed the present invention within a piece a eyewear, a user is provided with the sense of security that the present invention has not fallen off the piece of eyewear the present invention is tracking. Also, the present invention can be more appealing to look at than big, bulky, attachable accessories, and is more cost effective than other accessories.

### SUMMARY OF THE INVENTION

The present invention is a wireless eyewear locating device that may comprise at least one of the following: a tracking apparatus; a communication receiver device; a controlling and/or operating software application utilized to control or operate at least one control device and/or communication transmitter device and/or communication receiver device and/or communication transmitter/receiver device; and/or at least one of a control device and/or a communication transmitter device and/or a communication transmitter/receiver device. At least one of the at least one tracking apparatus, and/or at least one control device, and/or at least one communication receiver device, and/or the at least one communication transmitter device, and/or the at least one communication transmitter/receiver device can receive and/or transmit at least one of the following signals: GPS, Wi-Fi, radio wave, Bluetooth, radio-frequency, sonar, sonic, audio, vibration, light, sound, and/or infrared. At least one communication receiver device, and/or at least one communication transmitter device, and/or at least one communication transmitter/receiver device can be attached or connected to, and/or located partially or wholly within or inside the tracking apparatus and/or is the tracking apparatus. The at least one tracking apparatus, and/or at least one control device, and/or communication receiver device and/or the at least one communication transmitter device, and/or the at least one communication transmitter/receiver device can further comprise at least one power source. The at least one power source further can be comprised of at least one of: at least one battery, at least one battery compartment, and/or at least one battery compartment door. At least one communication receiver device and/or at least one communication transmitter device and/or at least one communication transmitter/receiver device can be located within or is attached to at least one control device. The at least one control device can be at least one remote control, computer, input device, output device, tablet, smart phone, smart device, and/or a stationary, hand held, and/or mobile device. The at least one remote control may further comprise a button or other signal controller that, when depressed or initiated or activated, can send or receive at least one signal from or to the at least one communication transmitter device or communication transmitter/receiver device located in the at least one remote control to the at least one communication device receiver or communication transmitter/receiver device located in the at least one tracking apparatus. The at least one controlling and/or operating software application, when activated and/or instructed to, can send a signal from the at least one communication transmitter device or communication receiver/transmitter device located in control device to the tracking apparatus, and/or at least one communication receiver device, and/or receiver/transmitter device located in/on/as the at least one tracking apparatus. The at least one controlling and/or operating software application, when activated and/or instructed to, can send a signal from the at least one communication transmitter device or communication transmitter/receiver device located in the control device to the tracking apparatus and/or at least one communication receiver device and/or communication transmitter/receiver device located in/on/as the at least one tracking apparatus. The at least one tracking apparatus can be placed, embedded within, or built inside a uniquely designed piece(s) of eyewear that allows for the tracking apparatus to be placed, inserted or embedded within, and/or built inside said eyewear, or removably attached via an attaching mechanism to the outside of components of said eyewear, such as the nosepiece, nosepad, rim, earpiece, or temple, thus making the invention and the eyewear synergistic companions. The at least one tracking apparatus and/or control device can further comprise at least one of the following: a speaker, an audio or sound device, a lighting system, a light source, and/or a vibrating device. The at least one control device can send at least one signal from the at least one communication transmitter device or communication transmitter/receiver device located in the control device to the at least one communication receiver device or communication transmitter/receiver device located in/on/as tracking apparatus that results in the at least one speaker and/or audio device, if present, emitting a sound, the lighting system and/or light system, if present, illuminating, the vibrating device, if present, vibrating, and/or the at least one communication receiver device or communication transmitter/receiver device transmitting sending at least one signal to the at least one communication transmitter device or communication transmitter/receiver device. The wireless eyewear locating device can further comprise at least one of the following: at least one LED light; at least one switch and/or at least one sensor and/or at least one connector; circuitry to control at least one LED light; and/or a transparent and/or translucent flexible exterior material permitting the transmission of light. At least one of the following may be possible in the present invention: said at least one switch and/or at least one sensor and/or at least one connector can be sensed by and/or connected to electronics; said at least one switch and/or at least one sensor can be at least one of motion and/or acceleration and/or impact activated; motion and/or said at least one sensor output can cause electronics to remain active for a minimum period of time; if motion and/or said at least one sensor output has not caused activation for said minimum period of time, the electronics enters a low current sleep mode to conserve battery energy; motion and/or said at least one sensor output can initiate wake up of electronics from a low current mode; the wireless eyewear locating device further comprises electronics able to control the lighting of said at least one LED light in at least one sequence; and/or said at least one switch and/or at least one sensor activation can initiate at least one lighting sequence. At least one of the following may be possible in the present invention: lighting sequence is at least one of the following: repetitive, and/or random; lighting sequence can incorporate at least one of the following: constant timing, variable timing, and/or a dimming function; sensor can sense acoustic energy and/or audio from the environment and convert said acoustic energy and/or audio into a signal; and/or said at least one connector is a connector and/or jack for connecting to an audio source and/or power. Said signal can be resolved into frequency and/or amplitude and/or a combination thereof. Said frequency and/or amplitude and/or a combination thereof can control or affect the pattern and or intensity of LED lighting.

A method of use for a wireless eyewear locating device can comprise of at least one of the following steps: at least one of downloading, initiating, running, and/or operating the software application for the wireless eyewear locating device; at least one of placing the at least one tracking apparatus largely or completely within a piece of eyewear or attaching or removably attaching the at least one tracking apparatus to a piece of eyewear; at least one of turning the tracking apparatus on and/or activating the tracking apparatus or the tracking apparatus self initiating, turning on or engaging; inputting information/data, and/or sending information/data, and/or receiving information/data, from/to the at least one control device; retrieving information/data from the at least one tracking apparatus; and/or finding, locating, and/or retrieving the at least one tracking apparatus and/or eyewear based on the information, or other signals or interaction, received from the tracking apparatus. The method of use for a wireless eyewear locating device can further comprise at least one of the following steps: hearing at least one sound emitted from the at least one speaker and/or sound system located in the at least one tracking apparatus when the at least one control device sends information to, and retrieves information from the at least one tracking apparatus; seeing at least one light emitted from the at least one light source and/or lighting system located in the at least one tracking apparatus when the at least one control device sends information to, and/or retrieves information from the at least one tracking apparatus; feeling or listening for the vibration(s) of the at least one vibrating device located in the at least one tracking apparatus when the at least one control device sends information to, and retrieves information from the at least one tracking apparatus; the information/data, or other signals or interaction, between the at least one control device and the at least one tracking apparatus includes distance information between the devices; and/or the distance information between the at least one control device and the at least one tracking apparatus can be updated and/or continuously updated as it changes. The method of use for a wireless eyewear locating device can further comprise the step of removing the removeably attached at least one tracking apparatus from the at least one piece of eyewear. The method of use for a wireless eyewear locating device can further comprise the step of placing or attaching the at least one tracking apparatus to a new or the same piece of eyewear.

In one embodiment, the present invention can interface glasses, keys and cell phones by using an application and/or a device, which can be located on a key chain or similar holder, that will alert you to where both your glasses and phone are located.

Although preferred embodiments of the present invention have been described it will be understood by those skilled in the art that the present invention should not be limited to the described preferred embodiments. Rather, various changes and modifications can be made within the spirit and scope of the present invention.

### BRIEF DESCRIPTION OF THE DRAWINGS

FIG. 1 is an image of a piece of eyewear, namely a pair of eyeglasses, with an embedded tracking apparatus embedded within the frame of the eyewear.

FIG. 2 is an image of a piece of eyewear, namely a pair of eyeglasses, with a consumer insertable tracking apparatus inserted into the frame of the eyewear.

FIG. 3 is an image of a piece of eyewear, namely a pair of eyeglasses, with an attachable tracking apparatus attached to the frame of the eyewear.

FIG. 4 is an image of a piece of eyewear, namely a pair of eyeglasses.

### DETAILED DESCRIPTION OF THE DRAWINGS

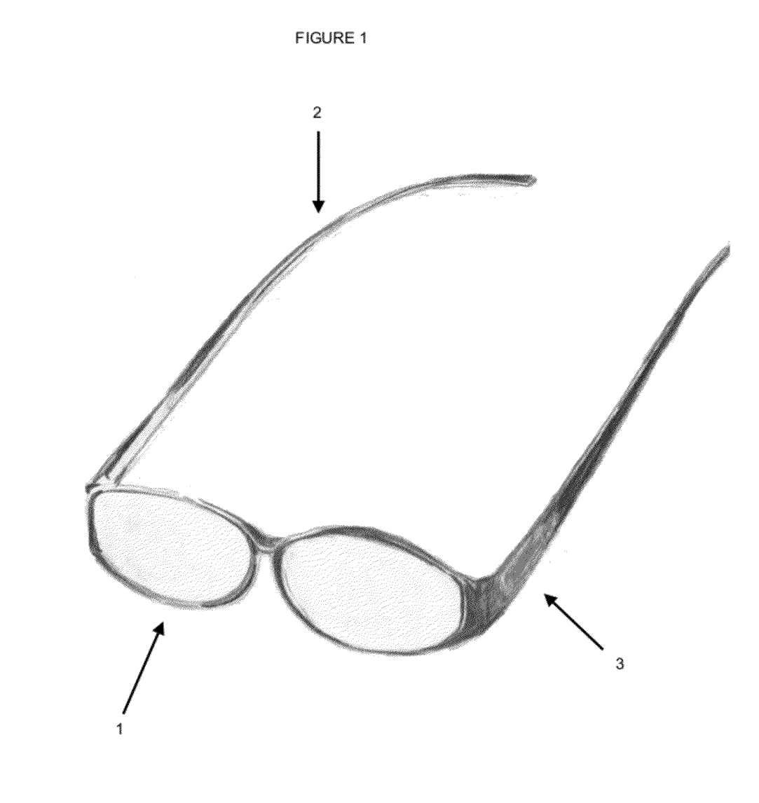

FIG. 1 is an image of a piece of eyewear 1, namely a pair of eyeglasses, with an embedded tracking apparatus 3 embedded within the frame 2 of the eyewear 1.

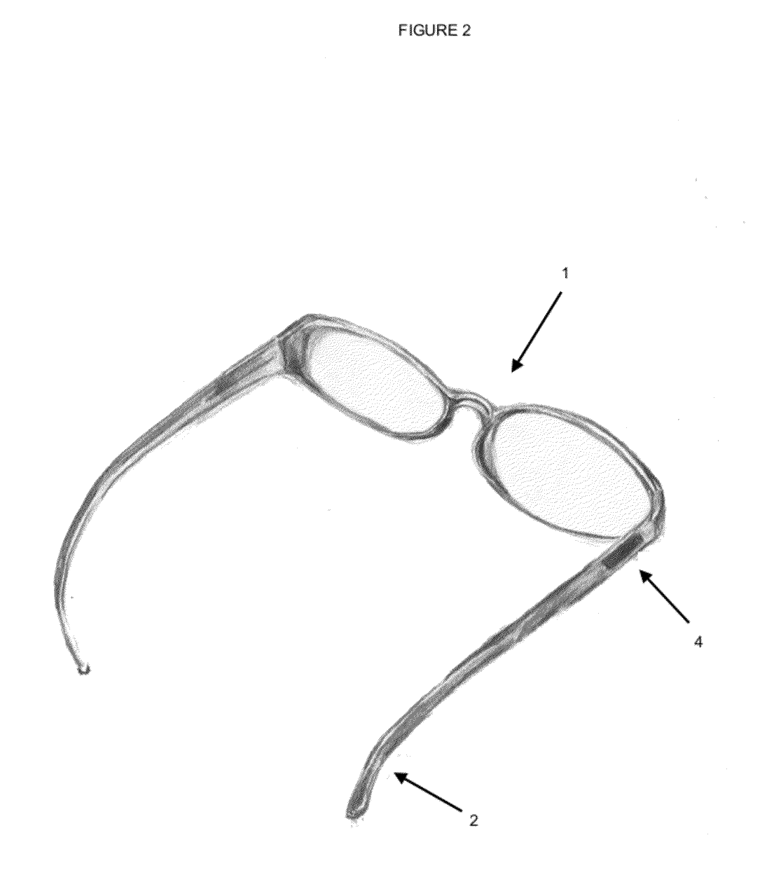

FIG. 2 is an image of a piece of eyewear 1, namely a pair of eyeglasses, with a consumer insertable tracking apparatus 4 inserted into the frame 2 of the eyewear 1.

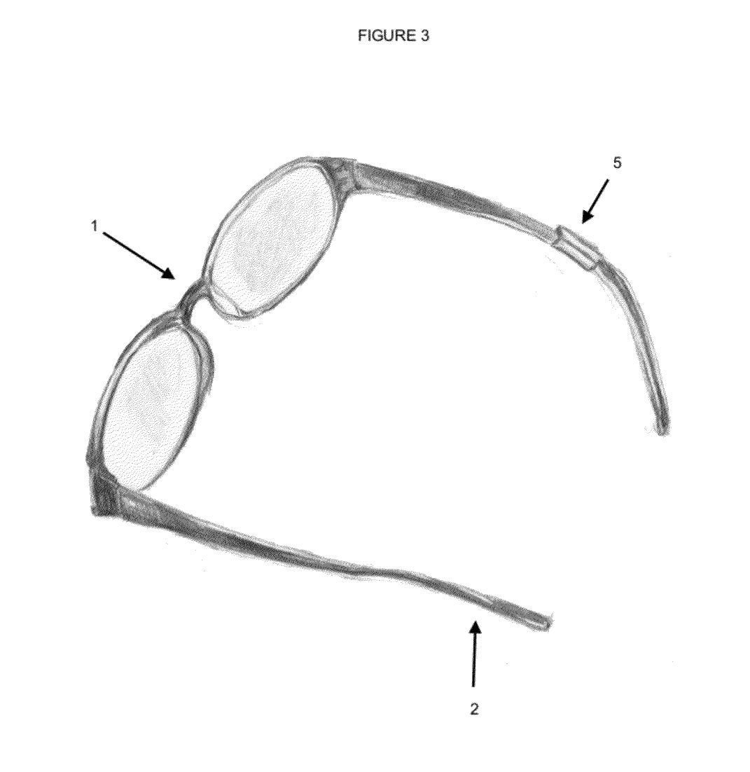

FIG. 3 is an image of a piece of eyewear 1, namely a pair of eyeglasses, with an attachable tracking apparatus 5 attached to the frame 2 of the eyewear 1.

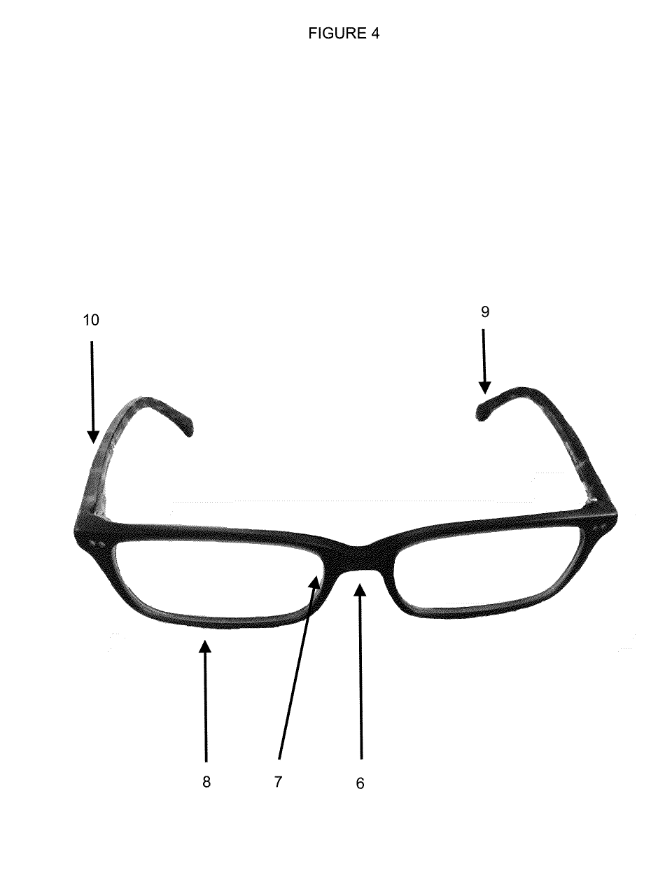

FIG. 4 is an image of a piece of eyewear 1, namely a pair of eyeglasses. The tracking apparatus of the present invention can be attached to and/or embedded within the components of a piece of eyewear 1, such as the frame 2, nosepiece 6, nose pads 7, rim 8, earpiece 9, or temple 10 of the piece of eyewear. The invention is designed to work with and/or attach to or be embedded into eyewear or eyewear frames made of all kinds of materials including but not limited plastic, metal, rubber, wood, glass, cloth, fabric, paper, cardboard, string, nylon, or any combination thereof.

Although preferred embodiments of the present invention have been described it will be understood by those skilled in the art that the present invention should not be limited to the described preferred embodiments. Rather, various changes and modifications can be made within the spirit and scope of the present invention.

### COMPONENT LIST FOR DRAWINGS

| Component No. | Component Description |
|---|---|
| 1 | Eyewear |
| 2 | Frame |
| 3 | Embedded tracking apparatus |
| 4 | Consumer insertable tracking apparatus |
| 5 | Attachable tracking apparatus |
| 6 | Nosepiece |
| 7 | Nose pads |
| 8 | Rim |
| 9 | Earpiece |
| 10 | Temple |

### DEFINITIONS

A “controlling and/or operating software application” is defined as a program used to control, operate, operate on at least one of the following: a stationary and/or mobile device, a tablet, smart phone, stationary phone, smart device, computer, hand held device, mobile phone, touch-screen computing device, portable media player, smart pad, smart device, laptop, desktop computer, micro device, portable device, technical device, virtual device, a remote control, a communication transmitter device, a communication transmitter/receiver device, a tracking apparatus, and/or a communication receiver device, among others.

A “remote control” is defined as an electronic device used to wirelessly control another electronic device.

A “stationary and/or mobile device” is defined as an electronic device that can be at least one of the following: a tablet, smart phone, stationary phone, smart device, computer, hand held device, mobile phone, touch-screen computing device, portable media player, smart pad, smart device, laptop, desktop computer, micro device, portable device, technical device, and/or virtual device.

A “communication receiver device” is defined as any electronic device that can receive signals such as GPS, Wi-Fi, radio wave, Bluetooth, radio-frequency, sonar, sonic, audio, and infrared.

A “communication transmitter device” is defined as any electronic device that can transmit signals such as GPS, Wi-Fi, radio wave, Bluetooth, radio-frequency, sonar, sonic, audio, and infrared.

A “communication transmitter/receiver device” is defined as any electronic device that can transmit and/or receive signals such as GPS, Wi-Fi, radio wave, Bluetooth, radio-frequency, sonar, sonic, audio, and infrared.

1. A wireless eyewear locating device comprised of the following:
a tracking apparatus;
wherein said tracking apparatus is placed completely within, or completely inserted within, a uniquely designed piece(s) of eyewear that allows for the tracking apparatus to be placed completely within, or completely inserted within, said eyewear, thus making the invention and the eyewear synergistic companions;
said tracking apparatus comprising at least one of a communication receiver device and/or a communication transmitter device and/or a communication transmitter/receiver device;
at least one of:
a controlling and/or operating software application utilized to control or operate at least one control device and/or communication transmitter device and/or communication receiver device and/or communication transmitter/receiver device; and/or
at least one of a control device and/or a communication receiver device and/or a communication transmitter device and/or a communication transmitter/receiver device;
at least one power source further comprised of at least one of: at least one battery and/or compositor, at least one battery compartment, and/or at least one battery compartment door;
the said at least one of a control device and/or a communication receiver device and/or a communication transmitter device and/or a communication transmitter/receiver device, if present, is at least one of: a computer, an input device, an output device, a tablet, smart phone, smart device, and/or a stationary, a hand held device, and/or mobile device;
the said tracking apparatus further comprised of at least one of the following: a speaker, an audio or sound device, a lighting system, a light source, and/or a vibrating device;
the said at least one control device sending at least one signal to at least one speaker and/or audio or sound device, if present, causing said speaker and/or audio or sound device to emit a sound, and/or the lighting system and/or light source, if present, causing said lighting system and/or light source to illuminate, and/or the vibrating device, if present, causing said vibrating device to vibrate, and/or the at least one communication receiver device or communication transmitter/receiver device transmitting sending at least one signal to the at least one communication transmitter device or communication transmitter/receiver device;
the said lighting system if present having at least one LED light used to generate at least one lighting sequence incorporating at least one of the following: constant timing, variable timing, and/or a dimming function; and further comprising at least one of the following: at least one switch and/or at least one sensor and/or at least one connector; circuitry to control at least one LED light; and/or a transparent and/or translucent flexible exterior material permitting the transmission of light.

2. The wireless eyewear locating device of claim 1 wherein at least one of the: at least one tracking apparatus, and/or at least one control device, and/or at least one communication receiver device, and/or the at least one communication transmitter device, and/or the at least one communication transmitter/receiver device can receive and/or transmit at least one of the following signals: GPS, Bluetooth, sonar, sonic, audio, vibration, light, sound, and/or infrared.

3. The wireless eyewear locating device of claim 1 wherein at least one communication receiver device and/or at least one communication transmitter device and/or at least one communication transmitter/receiver device is attached or connected to, and/or located partially or wholly within or inside the tracking apparatus and/or is the tracking apparatus.

4. The wireless eyewear locating device of claim 1 wherein the at least one tracking apparatus, and/or at least one control device, and/or communication receiver device and/or the at least one communication transmitter device, and/or the at least one communication transmitter/receiver device further comprises at least one additional power source.

5. (canceled)

6. (canceled)

7. (canceled)

8. (canceled)

9. (canceled)

10. The wireless eyewear locating device of claim 1 wherein the at least one controlling and/or operating software application, when activated and/or instructed to, sends a signal from the at least one communication transmitter device or communication transmitter/receiver device located in the control device to the tracking apparatus and/or at least one communication receiver device and/or communication transmitter/receiver device located in/on/as the at least one tracking apparatus.

11. (canceled)

12. (canceled)

13. (canceled)

14. A method of use for a wireless eyewear locating device comprised of at least one of the following steps:
at least one of downloading, initiating, running, and/or operating the software application for the wireless eyewear locating device;
at least one of placing the at least one tracking apparatus completely within a piece of eyewear;
at least one of turning the tracking apparatus on and/or activating the tracking apparatus or the tracking apparatus self initiating, turning on or engaging;
inputting information/data, and/or sending information/data, and/or receiving information/data, from/to the at least one control device;
retrieving information/data from the at least one tracking apparatus;
and/or
finding, locating, and/or retrieving the at least one tracking apparatus and/or eyewear based on the information, sounds, lighting, vibrations, or other signals or interaction, received from the tracking apparatus.

15. The method of use for a wireless eyewear locating device of claim 14 further comprising at least one of the following steps:
hearing at least one sound emitted from if present the at least one speaker and/or sound system located in the at least one tracking apparatus when the at least one control device sends information to, and retrieves information from the at least one tracking apparatus;
seeing at least one light emitted from if present the at least one light source and/or lighting system located in the at least one tracking apparatus when the at least one control device sends information to, and/or retrieves information from the at least one tracking apparatus;
feeling or listening for the vibration(s) of if present the at least one vibrating device located in the at least one tracking apparatus when the at least one control device sends information to, and retrieves information from the at least one tracking apparatus;
the information/data, or other signals or interaction, between the at least one control device if present and the at least one tracking apparatus includes distance information between the devices; and/or
the distance information between the at least one control device if present and the at least one tracking apparatus can be updated and/or continuously updated as it changes.

16. The method of use for a wireless eyewear locating device of claim 14 further comprising the step of removing the removeably attached at least one tracking apparatus from inside the at least one piece of eyewear.

17. The method of use for a wireless eyewear locating device of claim 16 further comprising the step of placing within or inserting the at least one tracking apparatus to a new or the same piece of eyewear.

18. (canceled)

19. The wireless eyewear locating device of claim 18 whereby at least one of the following:
if present said at least one switch and/or at least one sensor and/or at least one connector can be sensed by and/or connected to electronics;
if present said at least one switch and/or at least one sensor can be at least one of motion and/or acceleration and/or impact activated;
and if said at least one switch and/or at least one sensor is present:
motion and/or said at least one sensor output can cause electronics to remain active for a minimum period of time;
if motion and/or said at least one sensor output has not caused activation for said minimum period of time, the electronics enters a low current sleep mode to conserve battery energy;
motion and/or said at least one sensor output can initiate wake up of electronics from a low current mode;
the wireless eyewear locating device further comprises electronics able to control the lighting of said at least one LED light in at least one sequence;
and/or
said at least one switch and/or at least one sensor activation can initiate at least one lighting sequence.

20. The wireless eyewear locating device of claim 19 whereby at least one:
lighting sequence is at least one of the following: repetitive, and/or random;
sensor can sense acoustic energy and/or audio from the environment and convert said acoustic energy and/or audio into a signal; and/or
said at least one connector is a connector and/or jack for connecting to an audio source and/or power.

21. The wireless eyewear locating device of claim 20 whereby said signal can be resolved into frequency and/or amplitude and/or a combination thereof.

22. The wireless eyewear locating device of claim 21 whereby said frequency and/or amplitude and/or a combination thereof can control or affect the pattern and or intensity of LED lighting.
